(19) United States
(12) Patent Application Publication
(10) Pub. No.: US 2024/0160934 A1
(43) Pub. Date: May 16, 2024

(54) METHOD FOR REMOVING BRANCHES FROM TRAINED DEEP LEARNING MODELS

(71) Applicant: MEDIATEK INC., Hsinchu City (TW)

(72) Inventors: Hao CHEN, Hsinchu City (TW); Po-Hsiang YU, Hsinchu City (TW); Yu-Cheng LO, Hsinchu City (TW); Cheng-Yu YANG, Hsinchu City (TW); Peng-Wen CHEN, Hsinchu City (TW)

(21) Appl. No.: 18/450,571

(22) Filed: Aug. 16, 2023

Related U.S. Application Data
(60) Provisional application No. 63/383,513, filed on Nov. 14, 2022.

(51) Int. Cl. G06N 3/082

(52) U.S. Cl. CPC G06N 3/082

(57) ABSTRACT

A method for removing branches from trained deep learning models is provided. The method includes steps (i)-(v). In step (i), a trained model is obtained. The trained model has a branch structure involving one or more original convolutional layers and a shortcut connection. In step (ii), the shortcut connection is removed from the branch structure. In step (iii), a reparameterization model is built by linearly expanding each of the original convolutional layers into a reparameterization block in the reparameterization model. In step (iv), parameters of the reparameterization blocks are optimized by training the reparameterization model. In step (v), each of the optimized reparameterization blocks is transformed into a reparameterized convolutional layer to form a branchless structure that replaces the branch structure in the trained model.

### CROSS REFERENCE TO RELATED APPLICATIONS

This application claims the benefit of U.S. Provisional Application No. 63/383,513, filed on Nov. 14, 2022, the entirety of which is incorporated by reference herein.

### BACKGROUND OF THE INVENTION

### Field of the Invention

The present disclosure relates to the field of machine learning, and in particular to a method for removing branches from trained deep learning models.

### Description of the Related Art

Branching is a widely recognized technique to improve the accuracy of deep learning (DL) models. For instance, convolutional neural network (CNN)-based models like ResNet and DenseNet employ branches to transmit residual or concatenation information, mitigating the issue of gradient vanishing. However, the usage of branches can lead to increased DRAM traffic, which poses even greater challenges when the trained model is deployed on terminal devices with limited computational resources, such as mobile phones, smart watches, Internet of Things (IoT) devices, embedded systems used for monitoring and controlling industrial processes, and so on. Consequently, manufacturers and DL experts often invest significant effort in developing and training DL models that strike a delicate balance between accuracy and performance. This can slow down the product development process and eventually result in delayed product delivery.

In view of the issue described above, it would be desirable to have a method for removing branches from trained deep learning models without compromising the model's accuracy.

### BRIEF SUMMARY OF THE INVENTION

An embodiment of the present disclosure provides a method for removing branches from trained deep learning models. The method includes steps (i)-(v). In step (i), a trained model is obtained. The trained model has a branch structure involving one or more original convolutional layers and a shortcut connection. In step (ii), the shortcut connection is removed from the branch structure. In step (iii), a reparameterization model is built by linearly expanding each of the original convolutional layers into a reparameterization block in the reparameterization model. In step (iv), parameters of the reparameterization blocks are optimized by training the reparameterization model. In step (v), each of the optimized reparameterization blocks is transformed into a reparameterized convolutional layer to form a branchless structure that replaces the branch structure in the trained model.

In an embodiment, the reparameterization block expanded from the original convolutional layer using an original convolutional kernel with a size of N×N comprises a first sub-block, a second sub-block, a third sub-block, a fourth sub-block, a fifth sub-block, and a sixth sub-block, using convolutional kernels with sizes of 1×1, 1×1, N×N, N×1, 1×N, and 1×1, respectively. The first sub-block takes the original input of the original convolutional layer as input. The second sub-block, the third sub-block, the fourth sub-block, and the fifth sub-block take output from the first sub-block as input. The sixth sub-block takes outputs from the first sub-block, the second sub-block, the third sub-block, the fourth sub-block, and the fifth sub-block as input.

In an embodiment, step (v) further involves merging the convolutional kernels used by the first sub-block, the second sub-block, the third sub-block, the fourth sub-block, the fifth sub-block, and the sixth sub-block into a reparameterized convolutional kernel with a size of N×N used by the reparameterized convolutional layer.

In an embodiment, the first sub-block doubles the channel number of the original input. The second sub-block, the third sub-block, the fourth sub-block, and the fifth sub-block maintain the same channel number. The sixth sub-block restores the channel number to that of the original input.

In an embodiment, step (iv) further includes a step of inputting training data into the branch structure involving the original convolutional layers and the shortcut connection, and obtaining a first set of feature maps output by the branch structure. Step (iv) further includes a step of inputting the training data into the reparameterization model, and obtaining a second set of feature maps output by the reparameterization model. Step (iv) further includes a step of using a loss function to calculate a loss value for the first set of feature maps and the second set of feature maps. Step (iv) further includes a step of using an optimization algorithm to adjust the parameters of the reparameterization blocks based on the loss value.

In an embodiment, step (iv) further includes a step of inputting labeled data into the reparameterization model to perform a specific task, and obtaining prediction result output by the reparameterization model. Step (iv) further includes a step of using a loss function to calculate a loss value of the prediction result relative to a label of the labeled data. Step (iv) further includes a step of using an optimization algorithm to adjust the parameters of the reparameterization blocks in the reparameterization model based on the loss value.

In an embodiment, the trained model has a plurality of branch structures. Additionally, the method further includes a step of marking all the original convolutional layers of the trained model. The method further includes a step of searching for the next branch structure in the trained model. The method further includes a step of checking if all the original convolutional layers involved in the searched branch structure have a mark. The method further includes a step of unmarking all the original convolutional layers involved in the searched branch structure, performing steps (ii)-(v) on the searched branch structure, and searching for the next branch structure in the trained model.

Embodiments of the present disclosure provides a method for removing branches from trained deep learning models, transforming them into more hardware-friendly model suitable for deployment on a terminal device with limited computational resources, without compromising accuracy.

### BRIEF DESCRIPTION OF THE DRAWINGS

The present disclosure can be more fully understood by reading the subsequent detailed description and examples with references made to the accompanying drawings. Additionally, it should be appreciated that in the flow diagram of the present disclosure, the order of execution for each blocks can be changed, and/or some of the blocks can be changed, eliminated, or combined.

FIG. 1A is the flow diagram of a method for removing branches from trained deep learning models, according to an embodiment of the present disclosure;

FIG. 1B is the schematic diagram of a method for removing branches from trained deep learning models, according to an embodiment of the present disclosure;

FIG. 2 is the architecture diagram of a reparameterization block, according to an embodiment of the present disclosure;

FIG. 3A is the flow diagram of steps for training the reparameterization model, according to an embodiment of the present disclosure;

FIG. 3B is the flow diagram of steps for training the reparameterization model, according to another embodiment of the present disclosure;

FIG. 4 is the flow diagram of method for removing branches from trained deep learning models, according to an embodiment of the present disclosure; and

FIG. 5 is a schematic diagram illustrating the transformation process of an exemplary trained model with two branches during the execution of the method for removing branches from trained deep learning models, according to an embodiment of the present disclosure.

### DETAILED DESCRIPTION OF THE INVENTION

The following description provides embodiments of the invention, which are intended to describe the basic spirit of the invention, but is not intended to limit the invention. For the actual inventive content, reference must be made to the scope of the claims.

In each of the following embodiments, the same reference numbers represent identical or similar elements or components.

It must be understood that the terms “including” and “comprising” are used in the specification to indicate the existence of specific technical features, numerical values, method steps, process operations, elements and/or components, but do not exclude additional technical features, numerical values, method steps, process operations, elements, components, or any combination of the above.

Ordinal terms used in the claims, such as “first,” “second,” “third,” etc., are only for convenience of explanation, and do not imply any precedence relation between one another.

Embodiments of the present disclosure aim to provide a method for removing branches from trained deep learning models without compromising the model's accuracy. It should be noted that the examples illustrated in figures and the following specifications only show a few (e.g., one or two) branch structures and convolutional layers. This is only for the convenience of illustrating the embodiments of the present disclosure and is not for limiting sense. The embodiments of the present disclosure can be referenced and applied to real-world scenarios, where a trained deep learning model may have a large number of branch structures and convolutional layers.

It should be further noted that embodiments of the present disclosure focus on the operations performed on a model that has been trained and is about to be deployed in application scenarios. The manner in which the trained model was previously trained, as well as the specific task it is intended to perform, are not limited by the present disclosure.

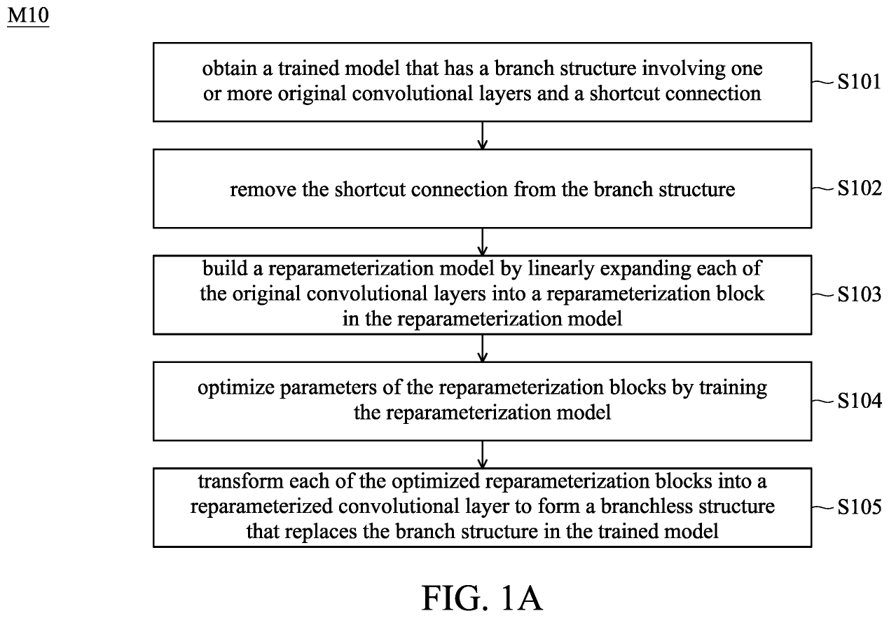

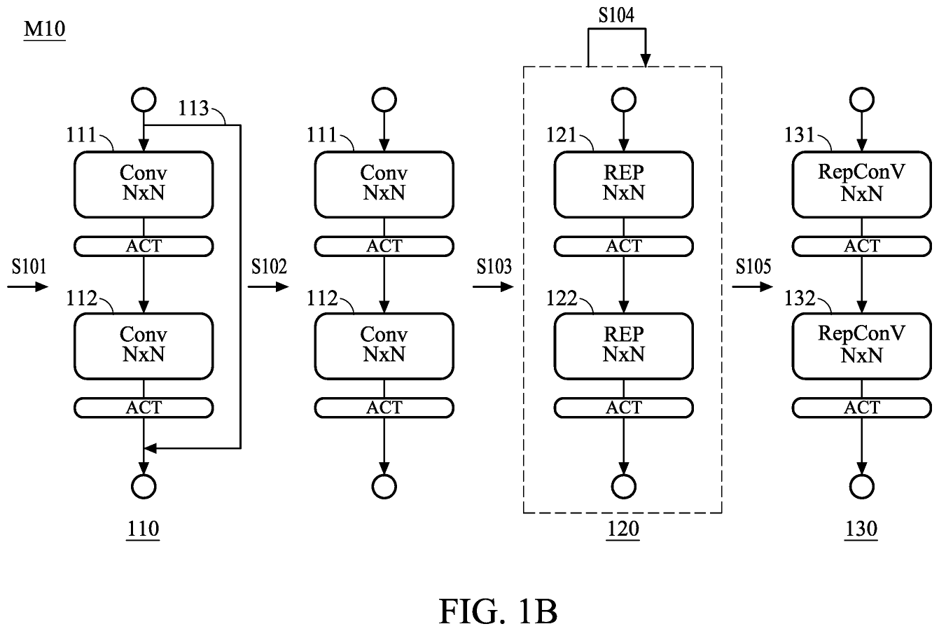

FIG. 1A is the flow diagram of a method M10 for removing branches from trained deep learning models, according to an embodiment of the present disclosure. As shown in FIG. 1A, the method M10 includes steps S101-S105. Correspondingly, FIG. 1B presents the schematic diagram of the method 100. For a better understanding of the embodiment of the present disclosure, please read the following descriptions with reference to both FIG. 1A and FIG. 1B.

In step S101, a trained model that has a branch structure involving one or more original convolutional layers and a shortcut connection is obtained. As shown in FIG. 1B, the obtained trained model has a branch structure 110 involving original convolutional layers 111,112 and the shortcut connection 113.

The mentioned trained model can be pre-trained using various techniques and datasets, and it can be applied to a wide range of image analysis and/or processing tasks, including but not limited to image recognition, object detection, image segmentation, image restoration, noise reduction, and more. The manner in which the trained model was previously trained, as well as the specific task it is intended to perform, are not limited by the present disclosure.

The mentioned convolution layers, such as the convolution layers 111 and 112 shown in FIG. 1B, perform a convolutional operation utilizing convolutional kernels with a size of N×N to extract feature representations from their inputs, generating output in the form of feature maps. N is typically chosen to be an odd number greater than 1 for several reasons, but the present disclosure is not limited thereto. During this convolutional process, each convolutional kernel slides across the input data, applying convolution operations at different locations, and generating feature maps that capture specific patterns and spatial information from the input. The output feature maps are forwarded to subsequent layers in the trained model, where they undergo further extraction and learning of higher-level features, in order to facilitate the model to perform specific tasks.

The mentioned shortcut connection (also referred to as “skip connection”), such as the shortcut connection 113 shown in FIG. 1B, plays a crucial role in a branch structure by enabling the flow of information and gradients from one layer to another, bypassing one or more intermediate layers. As shown in FIG. 1B, shortcut connection 113 bypasses the original convolutional layers 111 and 112, forwarding the input of the original convolutional layers 111 and 112 along with the feature maps output by these layers to subsequent layers. The primary purpose of shortcut connections is to address the vanishing gradient problem that can occur during training, where gradients become extremely small as they backpropagate through numerous layers. By providing a shortcut path, gradient flow is facilitated, allowing more efficient learning and preventing the degradation of performance. However, shortcut connections can lead to poor performance, especially when the trained model is deployed on terminal devices with limited computational resources. Therefore, in the present disclosure, the aim is to remove such shortcut connections from the trained model and replace the original branch structure with a reparameterized convolutional structure without shortcut connections.

In step S102, the shortcut connection is removed from the branch structure. As shown in FIG. 1B, the shortcut connection 113 is removed from the branch structure 110 through the execution of step S102. As a result, the original convolutional layers 111 and 112 are isolated from the branch structure 110.

In step S103, a reparameterization model is built by linearly expanding each of the original convolutional layers into a reparameterization block in the re-parameterization model. As shown in FIG. 1B, the built reparameterization model S103 includes the reparameterization blocks 121 and 122, which are linearly expanded from the original convolutional layers 111 and 112, respectively.

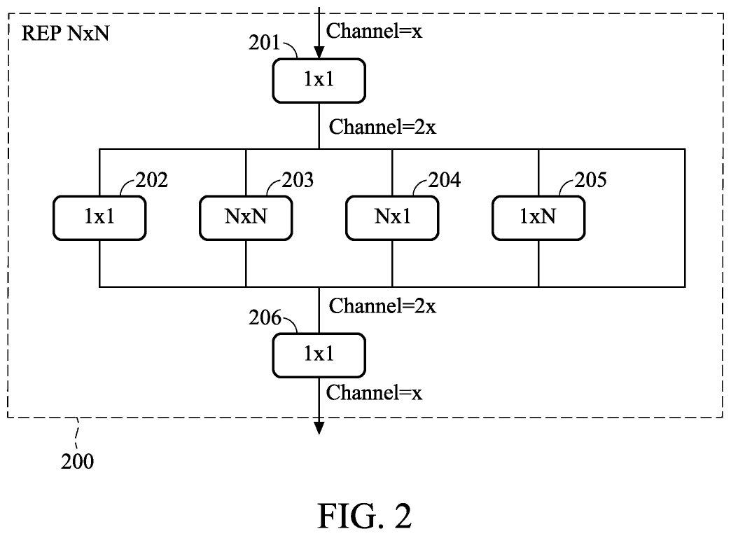

The architecture of the reparameterization block can be designed to encompass any domain resulting from the linear expansion of the original convolutional layers, and the present disclosure is not limited to any specific form. The design and composition of the reparameterization block can be customized to meet specific requirements and objectives, such as optimizing the performance of the trained model in resource-constrained scenarios. Additionally, the reparameterization process may involve the manipulation of various parameters, activation functions, and other architectural elements, enabling flexibility in adapting the reparameterization model to different deep learning architectures and tasks. However, it should be noted that the reparameterization model introduced in step S103 is designed to transform the original branch structure into a more efficient and streamlined form with no shortcut connections, while still preserving the essential characteristics and behavior of the original branch structure. The choice of specific reparameterization techniques and strategies can be dependent on several factors, such as the characteristics of the trained model, the desired trade-offs between accuracy and computational efficiency, the targeted application scenarios, and so on. A preferred embodiment, in which the architecture of the reparameterization block excels in both performance and model accuracy in most image analysis and/or processing scenarios, will be illustrated with reference to FIG. 2.

FIG. 2 is the architecture diagram of a reparameterization block 200, according to an embodiment of the present disclosure. The illustration of FIG. 2 presumes that the reparameterization block 200 is expanded from an original convolutional layer using an original convolutional kernel a size of size N×N. Therefore, the reparameterization block 200 is also presumed to have a size of N×N. As previously mentioned, N is typically chosen to be an odd number greater than 1 for several reasons, but the present disclosure is not limited thereto. As shown in FIG. 2, the reparameterization block 200 includes the first sub-block 201, the second sub-block 202, the third sub-block 203, the fourth sub-block 204, the fifth sub-block 205, and the sixth sub-block 206, using convolutional kernels with sizes of 1×1, 1×1, N×N, N×1, 1×N, and 1×1, respectively. Essentially, these sub-blocks 201-206 represent specific convolutional operations, resulting in the generation of output in the form of feature maps.

The reparameterization block 200 has a three-layer architecture, with specific sub-blocks at each layer. The first sub-block 201 is located at the first layer and takes the original input of the original convolutional layer as input. The second sub-block 202, the third sub-block 203, the fourth sub-block 204, and the fifth sub-block 205 are located at the second layer and take the output of the first sub-block 201 as input. The sixth sub-block 206 is located at the third layer and takes outputs from the first sub-block 201, the second sub-block 202, the third sub-block 203, the fourth sub-block 204, and the fifth sub-block 205 as input. As a result, the output of the first sub-block 201 at the first layer is forwarded to the fifth sub-block 205 at the third layer through pathways involving the second sub-block 202, the third sub-block 203, the fourth sub-block 204, the fifth sub-block 205, and a shortcut connection at the second layer.

In a further embodiment, the first sub-block 201 doubles the channel number of the original input. This is achieved by using convolutional kernels with size of 1×1 and setting the number of output channels to twice the number of input channels. As a result, the first sub-block 201 generates output feature maps with doubled channel number at the first layer. Meanwhile, the second sub-block 202, the third sub-block 203, the fourth sub-block 204, and the fifth sub-block 205 maintain the same channel number, making the channel number remains doubled at the second layer. Subsequently, the sixth sub-block 206 restores the channel number to that of the original input, completing the pipeline of the reparameterization block 200.

The elaborately designed reparameterization block 200 brings three major benefits. First, the presence of a shortcut connection between the first sub-block 201 and the sixth sub-block 206 facilitates the transmission of residual or concatenation information, thereby mitigating the potential risk of gradient vanishing. Second, the second sub-block 202, the fourth sub-block 204, and the fifth sub-block 205 offer multiple receptive fields for capturing features, enhancing the accuracy of the reparameterization block 200. Third, the doubled channel number at the second layer, where the second sub-block 202, the third sub-block 203, the fourth sub-block 204, and the fifth sub-block 205 are located, provides a higher number of learnable parameters for these sub-blocks.

Please refer back to FIG. 1A and FIG. 1B. In step S104, parameters of the reparameterization blocks are optimized by training the reparameterization model. As shown in FIG. 1B, parameters of the reparameterization blocks 121 and 122 are optimized by training the reparameterization model 120.

The training of the reparameterization model can be accomplished through supervised-learning or unsupervised-learning approaches. In supervised learning approaches, large amount of labeled training data will be fed into the reparameterization model to perform specific tasks, such as image recognition, object detection, image segmentation, image restoration, noise reduction, etc. The parameters of the reparameterization model can be optimized using an optimization algorithm (e.g., gradient decent) targeted to minimize task-specific loss functions, such as Mean Squared Error (MSE), Cross-Entropy, and custom loss functions tailored to the specific tasks. These loss functions are used to quantify the difference between the model's output and the ground truth, namely the lable of the labeled data. On the other hand, in unsupervised learning approaches, unlabeled training data is fed into both the original branch structure and the reparameterization model, and branch structure's output is used as “psudo-labels” to guide the training of the reparameterization model. More specifically, a distance or divergence measure (e.g., Mean Squared Error, cross entropy, KL divergence, etc.) is used to compute the loss value that represents the difference between their output feature maps. The objective of the optimization is to make the reparameterization model's output as close as possible to the branch structure's output, thereby learning from the knowledge of the branch structure. The advantage of the supervised learning approach is that it allows the reparameterization model to be optimized specifically for the target tasks of the trained model, leading to potentially better performance for those tasks. On the other hand, the advantage of the unsupervised-learning approach is that it leverages an existing branch structure from a trained model as a foundation to build the reparameterization model, allowing the reparameterization process to be executed on resource-limited devices, without the need to accommodate large amounts of labeled data and computing resources.

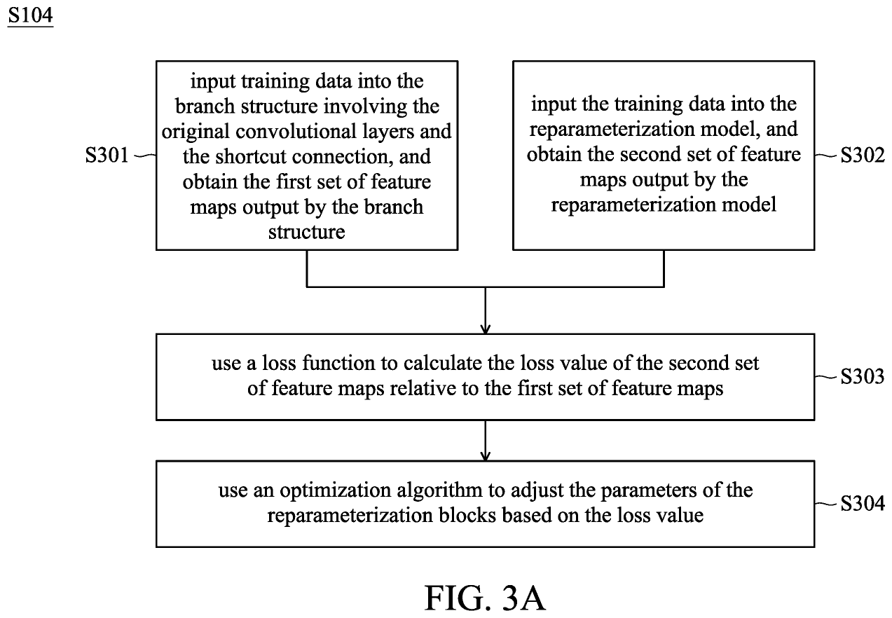

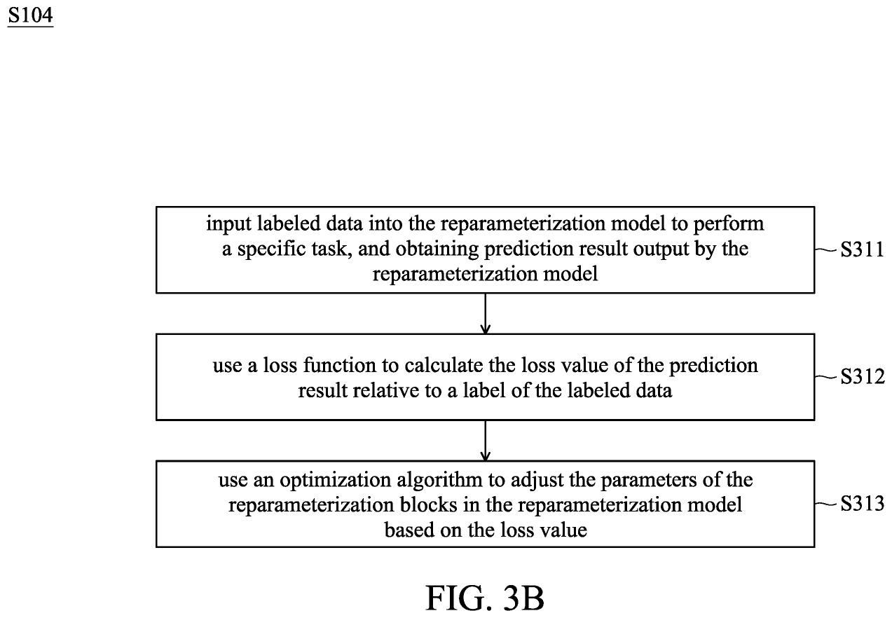

FIG. 3A is the flow diagram of an embodiment of step S104 in FIG. 1A and FIG. 1B, in which the previously introduced unsupervised-learning approach is adopted. As shown in FIG. 3A, step S104 may further include steps S301-304. It should be noted that steps S301 and S302 can be executed either in parallel or sequentially, and the present disclosure is not limited to a specific execution order.

In step S301, training data is input into the branch structure involving the original convolutional layers and the shortcut connection, and the first set of feature maps output by the branch structure is obtained. The training data is in the form of the original input of the original convolutional layer and can be either predefined or randomly generated, but the present disclosure is not limited thereto.

In step S302, the training data is input into the reparameterization model, and the second set of feature maps output by the reparameterization model is obtained.

In step S303, a loss function is used, to calculate the loss value of the second set of feature maps relative to the first set of feature maps. The loss function quantifies the relative differences between the first set of feature maps output by the branch structure and the second set of feature maps output by the reparameterization model, and it can be a distance or divergence measure, such as Mean Squared Error, cross entropy, KL divergence, Euclidean distance, Cosine distance, Manhattan distance, Minkowski distance, etc., but the present disclosure is not limited thereto.

In step S304, an optimization algorithm is used, to adjust the parameters of the reparameterization blocks based on the loss value calculated in step S303. The optimization algorithm can be gradient decent (GD), stochastic gradient descent (SGD), Broyden-Fletcher-Goldfarb-Shanno (BFGS), sequential quadratic programming (SQP), Genetic Algorithm (GA), Particle Swarm Optimization (PSO), Ant Colony Optimization (ACO), etc., but the present disclosure is not limited thereto.

FIG. 3B is the flow diagram of another embodiment of step S104 in FIG. 1A and FIG. 1B, in which the previously introduced supervised-learning approach is adopted. As shown in FIG. 3B, step S104 may further include steps S311-313.

In step S311, labeled data is input into the reparameterization model to perform a specific task, and prediction result output by the reparameterization model are obtained. The labeled data can be the same as the data used for training the trained model, but the present disclosure is not limited thereto. The specific task is the same as the task performed by the trained model, which can be image recognition, object detection, image segmentation, image restoration, noise reduction, etc., but the present disclosure is not limited to these tasks. The prediction result can be a scalar, a vector, a tensor, or any other data structure depending on the specific task and the architecture of the model. It may represent a single value, a set of values, or a multi-dimensional array, capturing various types of information such as class probabilities, regression values, semantic segmentation maps, or any other relevant information for the given task.

In step S312, a loss function is used, to calculate the loss value of the prediction result relative to the label of the labeled data. The label is used as the ground truth to evaluate the prediction result. The loss function quantifies the relative differences between the prediction result output and the label, and it can be any task-specific loss functions, such as Mean Squared Error (MSE), Cross-Entropy, and custom loss functions tailored to the specific tasks.

In step S313, an optimization algorithm is used, to adjust the parameters of the reparameterization blocks in the reparameterization model based on the loss value calculated in step S312. The optimization algorithm can be gradient descent (GD), stochastic gradient descent (SGD), Momentum, Adam, AdaGrad, and other variants, but the present disclosure is not limited thereto. The optimization algorithm may involve backpropagation, which initiates from the output layer of the reparameterization model and propagates backward through the reparameterization blocks to compute the gradients of the loss function with respect to each parameter of the reparameterization blocks in the reparameterization model. These gradients are then used to update the parameters iteratively, aiming to minimize the loss function during the training process.

Please refer back to FIG. 1A and FIG. 1B. In step S105, each of the optimized reparameterization blocks is transformed into a reparameterized convolutional layer to form a branchless structure that replaces the branch structure in the trained model. As shown in FIG. 1B, the optimized reparameterization blocks 121 and 122 are respectively transformed into the reparameterized convolutional layers 131 and 132, to form a branchless structure 130 that replaces the branch structure 110 in the trained model.

Additionally, the reparameterized convolutional layer uses the same size of convolutional kernels as the corresponding original convolutional layer. As shown in FIG. 1B, both the original convolutional layer 111 and the reparameterized convolutional layer 131 use the same kernel size of N×N.

In an embodiment, each of the reparameterization blocks, and each of the reparameterized convolutional layers, is connected to a non-linear mapping layer denoted by the symbol “ACT” in the figure. The non-linear mapping layer utilizes an activation function, such as ReLU, Sigmoid, Softmax, etc., to process the output of the reparameterized convolutional layers, resulting in enhanced non-linearity and feature expression. It should be noted that the parameters of the activation function are treated as hyperparameters, which will not be adjusted during the training of the reparameterization model.

In an embodiment, in which the reparameterized block 200 illustrated by FIG. 2 is included in the reparameterized model, step S105 further involves merging the convolutional kernels used by the first sub-block 201, the second sub-block 202, the third sub-block 203, the fourth sub-block 204, the fifth sub-block 205, and the sixth sub-block 206 into a reparameterized convolutional kernel with a size of N×N used by the reparameterized convolutional layer, according to the homogeneity and additivity of convolution. Homogeneity in convolution refers to the property that scaling the input to the convolution operation results in a corresponding scaling of the output. Additivity in convolution refers to the property that when multiple inputs of the convolution operation is added, the output is equal to the sum of the individual outputs obtained from each input. The homogeneity and additivity properties of convolution allow for the aggregation of convolutional kernels from different sub-blocks into a unified reparameterized convolutional kernel.

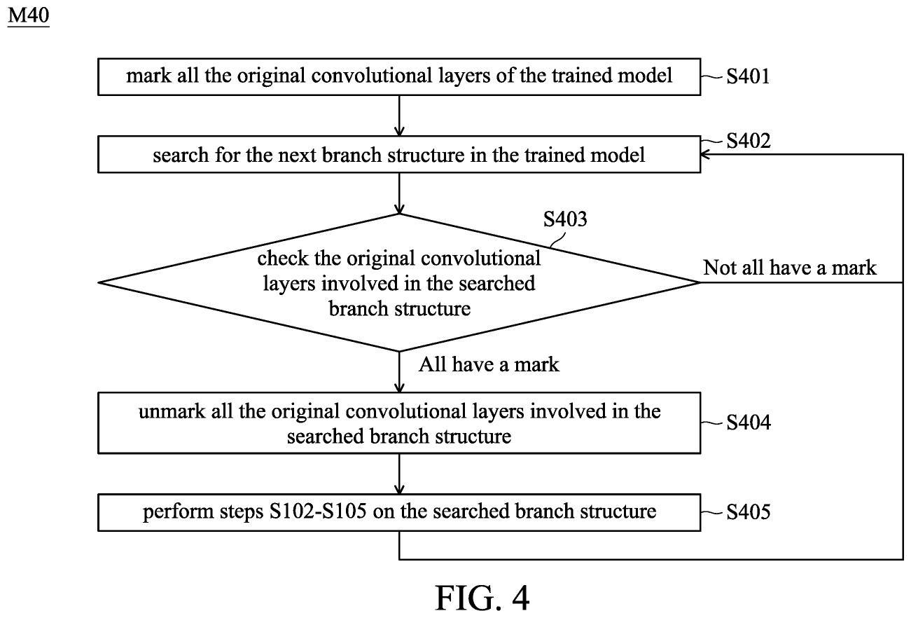

FIG. 4 is the flow diagram of method M40 for removing branches from trained deep learning models, according to an embodiment of the present disclosure. In this embodiment, the trained model has a plurality of branch structures to be replaced. As shown in FIG. 4, the method M40 may include steps S401-S405.

In step S401, all the original convolutional layers of the trained model are marked.

In step S402, the next branch structure in the trained model is searched for.

In step S403, the original convolutional layers involved in the searched branch structure are checked if all of them have a mark. If they all have a mark, method M40 proceeds to step S404. If not all of them have a mark, method M40 returns to step S402 to search for the next branch structure in the trained model.

In step S404, all the original convolutional layers involved in the searched branch structure are unmarked. In other words, the marks are removed from these original convolutional layers.

In step S405, steps S102-S105 in FIG. 1A are performed on the searched branch structure. As a result, the searched branch structure is replaced by a branchless structure consisting of reparameterized convolutional layers and no shortcut connections. Subsequently, method M40 returns to step S402 to search for the next branch structure in the trained model.

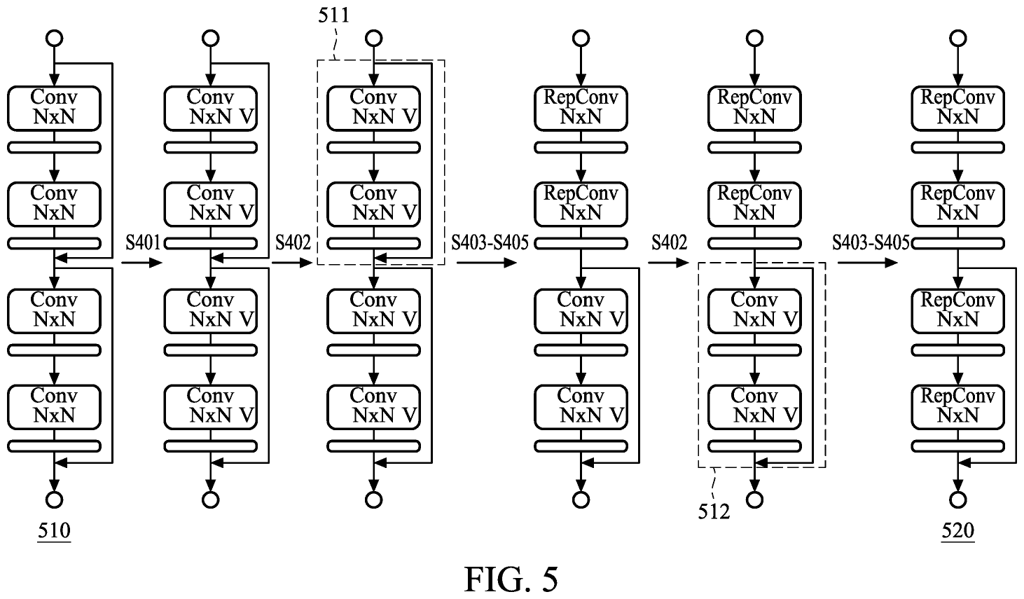

FIG. 5 is a schematic diagram illustrating the transformation process of an exemplary trained model 510 with two branches during the execution of method M40, according to an embodiment of the present disclosure. As shown in FIG. 5, through step S401, all the original convolutional layers of the trained model 510 are marked with a symbol denoted by “V” in the figure. Then, through step S402, the first branch structure 511 of the trained model 511 is identified and targeted. Subsequently, through steps S403 to S405, the first branch structure 511 is replaced by a branchless structure consisting of two reparameterized convolutional layers and no shortcut connections. Afterward, upon revisiting step S402, the second branch structure 512 is identified and targeted. Once again, through steps S403 to S405, the second branch structure 512 is replaced by another branchless structure consisting of two reparameterized convolutional layers and no shortcut connections. As a result, both the first branch structure 511 and the second branch structure 512 are replaced by branchless structures, transforming the trained model 510 into the reparameterized model 520 with no branches. At this point, the reparameterized model 520 is suitable for deployment on a terminal device with limited computational resources.

Embodiments of the present disclosure provides a method for removing branches from trained deep learning models, transforming them into more hardware-friendly model suitable for deployment on a terminal device with limited computational resources, without compromising accuracy.

The steps of the methods and algorithms provided in the present disclosure may be directly applied to a hardware and a software module or the combination thereof by executing a processor. A software module (including executing instructions and related data) and other data may be stored in a data memory, such as random access memory (RAM), flash memory, read-only memory (ROM), erasable programmable read only memory (EPROM), electrically erasable programmable read only memory (EEPROM), registers, hard drives, portable drives, CD-ROM, DVD, or any other computer-readable storage media format in the art. For example, a storage media may be coupled to a machine device, such as a computer/processor (denoted by “processor” in the present disclosure, for the convenience of explanation). The processor may read information (such as codes) from and write information to a storage media. A storage media may integrate a processor. An application-specific integrated circuit (ASIC) includes the processor and the storage media. A user apparatus includes an ASIC. In other words, the processor and the storage media are included in the user apparatus without directly connecting to the user apparatus. Besides, in some embodiments, any product suitable for computer programs includes a readable storage media, wherein the storage media includes codes related to one or more disclosed embodiments. In some embodiments, the computer program product may include packaging materials.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for removing branches from trained deep learning models, comprising the following steps:
(i) obtaining a trained model that has a branch structure involving one or more original convolutional layers and a shortcut connection;
(ii) removing the shortcut connection from the branch structure;
(iii) building a reparameterization model by linearly expanding each of the original convolutional layers into a reparameterization block in the reparameterization model;
(iv) optimizing parameters of the reparameterization blocks by training the reparameterization model; and
(v) transforming each of the optimized reparameterization blocks into a reparameterized convolutional layer to form a branchless structure that replaces the branch structure in the trained model.

2. The method as claimed in claim 1, wherein the reparameterization block expanded from the original convolutional layer using an original convolutional kernel with a size of N×N comprises a first sub-block, a second sub-block, a third sub-block, a fourth sub-block, a fifth sub-block, and a sixth sub-block, using convolutional kernels with sizes of 1×1, 1×1, N×N, N×1, 1×N, and 1×1, respectively;
wherein the first sub-block takes original input of the original convolutional layer as input;
wherein the second sub-block, the third sub-block, the fourth sub-block, and the fifth sub-block take output from the first sub-block as input;
wherein the sixth sub-block takes outputs from the first sub-block, the second sub-block, the third sub-block, the fourth sub-block, and the fifth sub-block as input.

3. The method as claimed in claim 2, wherein step (v) further comprises:
merging the convolutional kernels used by the first sub-block, the second sub-block, the third sub-block, the fourth sub-block, the fifth sub-block, and the sixth sub-block into a reparameterized convolutional kernel with a size of N×N used by the reparameterized convolutional layer.

4. The method as claimed in claim 2, wherein the first sub-block doubles channel number of the original input;
wherein the second sub-block, the third sub-block, the fourth sub-block, and the fifth sub-block maintain the same channel number; and
wherein the sixth sub-block restores the channel number to that of the original input.

5. The method as claimed in claim 1, wherein step (iv) further comprises:
inputting training data into the branch structure involving the original convolutional layers and the shortcut connection, and obtaining a first set of feature maps output by the branch structure;
inputting the training data into the reparameterization model, and obtaining a second set of feature maps output by the reparameterization model;
using a loss function to calculate a loss value of the second set of feature maps relative to the first set of feature maps; and
using an optimization algorithm to adjust the parameters of the reparameterization blocks based on the loss value.

6. The method as claimed in claim 1, wherein step (iv) further comprises:
inputting labeled data into the reparameterization model to perform a specific task, and obtaining prediction result output by the reparameterization model;
using a loss function to calculate a loss value of the prediction result relative to a label of the labeled data;
using an optimization algorithm to adjust the parameters of the reparameterization blocks in the reparameterization model based on the loss value.

7. The method as claimed in claim 1, wherein the trained model has a plurality of branch structures, and the method further comprises:
marking all the original convolutional layers of the trained model;
searching for the next branch structure in the trained model;
checking if all the original convolutional layers involved in the searched branch structure have a mark;
in response to all the original convolutional layers involved in the searched branch structure having the mark, unmarking all the original convolutional layers involved in the searched branch structure, performing steps (ii)-(v) on the searched branch structure, and searching for the next branch structure in the trained model.
